(19) United States
(12) Patent Application Publication
(10) Pub. No.: US 2003/0095185 A1
(43) Pub. Date: May 22, 2003

(54) Electronic door viewer and method of use

(76) Inventor: Bill R. Naifeh, Dallas, TX (US)

Correspondence Address: Bill R. Naifeh, 7826 Yamini Drive, Dallas, TX, 75230, US

(21) Appl. No.: 10/295,143

(22) Filed: Nov. 15, 2002

Related U.S. Application Data
(60) Provisional application No. 60/331,885, filed on Nov. 19, 2001.

(51) Int. Cl. H04N 7/18

(52) U.S. Cl. 348/156; 348/143

(57) ABSTRACT

One embodiment of the present invention is a door viewer comprising a light sensing means coupled to an exterior side of a door, an image system for receiving and processing the signals from the light sensing means, and a display mechanically coupled to the interior side of the door and in communication with the image processing system such that image signals from the image system may be viewed on the display.

In another embodiment, the door viewer is coupled to a motion detecting device such that when an outsider approaches the door, a digital camera records and stores an image of the person. The resident can later determine who approached the door by reviewing the stored images from a display coupled to the interior side of a door.

### CROSS REFERENCE TO RELATED APPLICATIONS

This application claims the benefit of the filing date of U.S. provisional patent application serial No. 60/331,885, filed on Nov. 19, 2001, which is hereby incorporated by reference. A PCT Application No. ______, entitled Electronic Door Viewer and Method of Use, was filed on ______ with the United States Receiving Office, designating the USPTO as the International Searching Authority. This PCT Application also claims priority of U.S. provisional patent application No. 60/331,885.

### TECHNICAL FIELD

The invention relates in general to security devices, and in particular to door viewers set in doors and walls of apartments, houses, and buildings.

### BACKGROUND INFORMATION

Conventional door viewers or “peep holes” are typically installed through a door by drilling a bore through the door and installing some type of optical system in a cylindrical shaped housing within the bore. Usually, the optical system is a reverse Galileo-type arrangement where the lens of the system are aligned along a longitudinal axis. Such door viewers are well known and commonly used in apartments and houses.

Generally, it is preferable that the cylindrical-shaped housing and lens have a relatively small diameter so as not to be conspicuous when seen from the outside. Therefore, the eyepiece of the optical system is also required to be relatively small. Consequently, the home or apartment occupant or “user” must approach the eyepiece so that the distance between the user's eye and the eyepiece is with a few centimeters. This is not convenient and may be difficult for users whose height is not within a particular range.

At night and during conditions of low external light, an outsider may be able to determine when the user has approached the eyepiece because the user's head will block the light traveling from the inside of the dwelling to the outside. An outsider, such as a salesman, may then become more aggressive and intimidate the user into opening the door. In any event, many users do not wish for outsiders to know that they are either home or near the door.

Additionally, in many situations the outsider may be a burglar or intruder. Many burglars do not wish to confront a home owner or apartment dweller. Consequently, many intruders will approach the door and ring the door bell or knock to determine if the occupant is in the dwelling. If no one responds, in many cases, the intruder will gain entrance to the dwelling by simply kicking or applying force to the door, or by gaining entrance through a less obvious entrance, such as a side door.

Worse still, are situations where the intruder confronts the home owner. The intruder may harm or murder the home owner. Under the trauma of a confrontation, if the victim survives, the victim may not be able to accurately describe the intruder. If the victim suffers severe injury or death, no description of the intruder will be given. A video record or photograph of all approaching outsiders may greatly assist authorities in identifying and apprehending intruders.

Large homes and commercial office buildings often have elaborate security systems with video cameras and monitors. However, such systems are expensive, cumbersome, and difficult to install. Installation and maintenance of such systems are usually performed by professional security providers. Therefore, these systems may not be affordable to many home owners and small business owners. Furthermore, these systems are not practical for most apartment dwellers who are not able to permanently alter their apartment buildings with elaborate systems.

What is needed, therefore, is a device that allows the user to conveniently see the outsider without the outsider knowing that he or she is being viewed. Additionally, what is need is a relatively inexpensive apparatus and method which creates a visual record of outsiders approaching an exterior door or wall.

### SUMMARY OF THE INVENTION

The previously mentioned needs are fulfilled with the various embodiments of the present invention. One embodiment of the present invention is a door viewer comprising a light sensing means coupled to an exterior side of a door, an image system for receiving and processing the signals from the light sensing means, and a display viewable from the interior side of the door and in communication with the image processing system such that image signals from the image system may be viewed on the display.

In another embodiment, the door viewer is coupled to a motion detecting device such that when an outsider approaches the door, the system records and stores an image of the approaching person. The resident can later determine who approached the door by reviewing the stored images from a display coupled to the interior side of a door. Other embodiments have intercom systems so that the user can communicate with the outside without having to open the door. In yet another embodiment, there is a door having an integrated module comprising a image gathering element, a small computer processor for processing images, and a storage system for recording images of persons approaching the door.

These and other features, and advantages, will be more clearly understood from the following detailed description taken in conjunction with the accompanying drawings. It is important to note the drawings are not intended to represent the only form of the invention.

### BRIEF DESCRIPTION OF THE DRAWINGS

FIG. 1 is an isometric view incorporating one embodiment of the present invention.

FIG. 2 is a partial isometric exploded view of the embodiment illustrated in FIG. 1.

FIG. 3A is a partial section view showing an example mounting aspect of the embodiment of FIG. 1.

FIG. 3B is a partial section view showing an alternative example mounting aspect of the embodiment of FIG. 1.

FIG. 4 is a functional block diagram incorporating one aspect of the present invention.

FIG. 5 is another functional block diagram incorporating one aspect of the present invention.

FIG. 6 is a front view of a door viewer incorporating one aspect of the present invention.

FIG. 7a illustrates and example menu structure which could be used in some embodiments of the present invention.

FIG. 7b illustrates and example menu structure which could be used in some embodiments of the present invention.

FIG. 8 is an isometric view incorporating an alternative embodiment of the present invention.

FIG. 9 is a functional block diagram incorporating one aspect of the present invention.

FIG. 10 is a front view of a door viewer incorporating an alternative aspect of the present invention.

FIG. 11 is an isometric view incorporating an alternative embodiment of the present invention.

FIG. 12a is an isometric view of a modular component incorporating an aspect of an alternative embodiment.

FIG. 12b is an isometric view of a modular component incorporating an aspect of an alternative embodiment.

FIG. 12c is an isometric view of a modular component incorporating an aspect of an alternative embodiment.

FIG. 13 is a functional block diagram incorporating one aspect of the alternative embodiment illustrated in FIGS. 12a, 12b, and 12c.

### DETAILED DESCRIPTION OF THE INVENTION

The principles of the present invention and their advantages are best understood by referring to the illustrated embodiments depicted in FIGS. 1-13 of the drawings, in which like numbers designate like parts. In the following description, well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry and specific software routines described herein are omitted, as such control circuits and software are within the skills of persons of ordinary skill in the relevant art.

Turning now to FIG. 1., there is one embodiment of the present invention generally shown as a viewer 100 comprising a lens holder 102, a cylindrical unit 104, a mounting unit 105, an enclosure or housing 106, a flat panel display 108, and a user control panel 110. The lens holder 102 may be designed to hold a lens and/or a lens cover (not shown). The lens holder 102 and cylindrical unit 104 may be mounted on a first or exterior side of a door or wall such that the lens is capable of focusing light from the exterior side of the door or wall. The lens holder 102 may be made of plastic, brass, or other suitable material and is coupled to the cylindrical unit 104. The cylindrical unit 104 may be mounted in a conventional bore through a conventional door (not shown in FIG. 1). The cylindrical unit 104 is also made of brass or another suitable material and may be cast integrally with lens holder 102. In the illustrative embodiment, the cylindrical unit 104 houses a image pickup unit (not shown in FIG. 1). The image pickup unit is aligned with the lens such that the lens focuses and directs light to pickup elements or sensors of the image pickup unit. In this embodiment, the lens holder may be designed so that from the exterior side of the door, the lens holder looks like a conventional door viewer.

The cylindrical unit 104 may have male screw threads 103 on its outer periphery. As viewed in FIG. 1, the mounting unit 105 partially covers the cylindrical unit 104. The mounting unit 105 is tubular in shape and has female screw threads (not shown) on its interior walls to mesh with the male screw threads 103.

The cylindrical unit 104 is coupled to the housing 106 via the mounting unit 105 such that lens holder 102 may be on an exterior side of a door and housing 106 is on the interior side of the door. In one embodiment, the housing 106 encompasses an image processing system (not shown) and a display unit 108. The display unit 108 may be of any suitable type, including a liquid crystal display panel (LCD), an organic light-emitting diode (OLED) display, a field emission display (FED), an active matrix display panel, a plasma display panel, or a digital micromirror device (DMD). The display 108 may display images in either in color or monochrome. Preferably, the display display unit 108 may be coupled to a back or side lightening unit (not shown) to allow the display 108 to be viewed in dimly lit conditions. In the embodiment illustrated in FIG. 1, the user interface or control panel 110 may be located adjacent to the display unit 104. In this embodiment, the control panel 110 has various buttons 112a through 112d, which as will be explained later, allow the user to control the operation of the viewer 100. In other embodiments, however, the display unit 108 could be touch a sensitive LCD display screen such as described in U.S. Pat. No. 5,623,280, which is hereby incorporated by reference. If a touch sensitive screen is employed, then the user interface would be incorporated into the touch sensitive screen.

In the illustrative embodiment, a light emitting diode (“LED”) 114 is also positioned close to the control buttons 112a-112d. The LED 104 may blink to signal to the user that there are stored images in the viewer that have not yet been viewed.

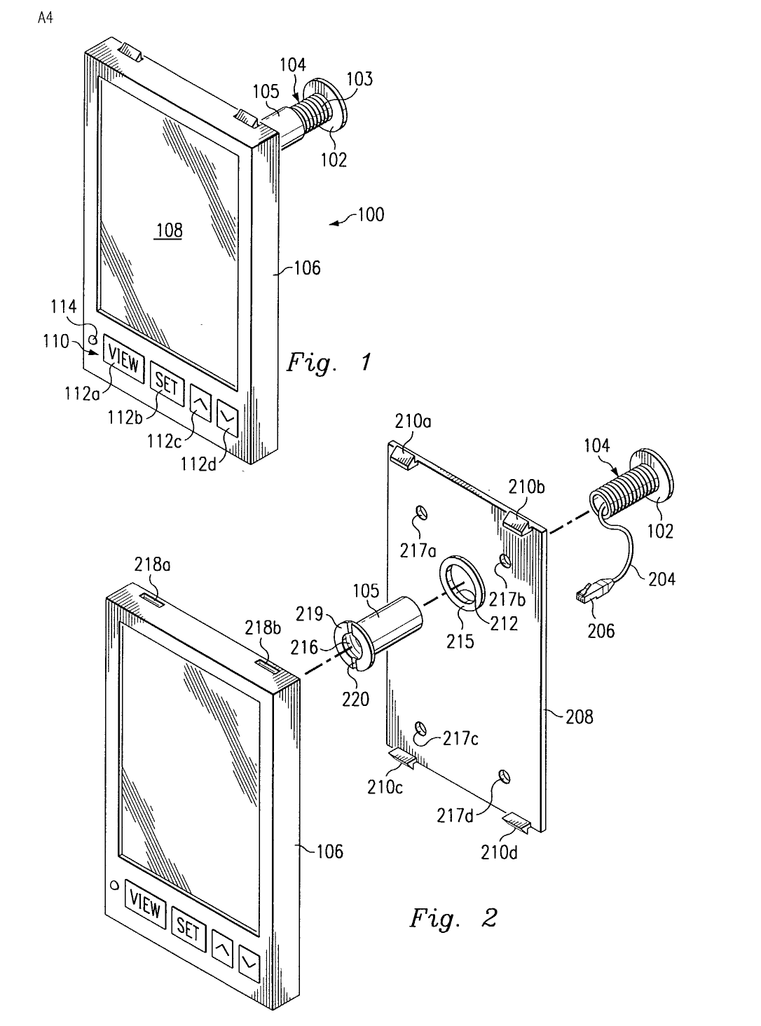

FIG. 2 is a partial exploded isometric view of the embodiment of FIG. 1. The cylindrical unit 104 is shown with cable 204. The cable 204 contains power, data, and control cables. One end of the cable 204 is coupled to an electrical connector 206. The electrical connector 206 mates with a corresponding connector (not shown) coupled to a primary control circuit and power source (not shown). The other end of the cable 204 is coupled to the image pickup unit located inside of cylindrical unit 104. Other embodiments may have independent power cables and various electrical connectsions, such as a USB compatible cable and connection.

Next shown is a mounting plate 208. In the embodiment illustrated in FIG. 2, the mounting plate 208 may be made of molded plastic, stamped sheet metal or any suitable material. In this embodiment, the mounting plate 208 has connections 210a through 210d to couple to longitudinal slots 218a through 218d of housing 106 (slots 218c and 218d are not shown in FIG. 2). The mounting plate 208 may be coupled to housing 106 in any number of methods including screws and/or more elaborate molded fittings.

Mounting plate 208 contains a mounting hole 212. The thickness of the mounting plate 208 may be increased around the mounting hole 212 to provide extra structural strength, as provided by a lip 215. The diameter of the mounting hole 212 is slightly larger than the exterior diameter of the mounting unit 105 such that the mounting unit can be inserted into the mounting hole 212. The mounting unit 105 has a head 219 with a groove 220. The groove 220 allows the mounting unit 105 to be screwed tightly over cylindrical unit 104 when installed in a door (not shown in FIG. 2).

The mounting plate 208 may also contain screw holes 217a through 217d. Screw holes 217a through 217d provide additional support for the mounting plate 208.

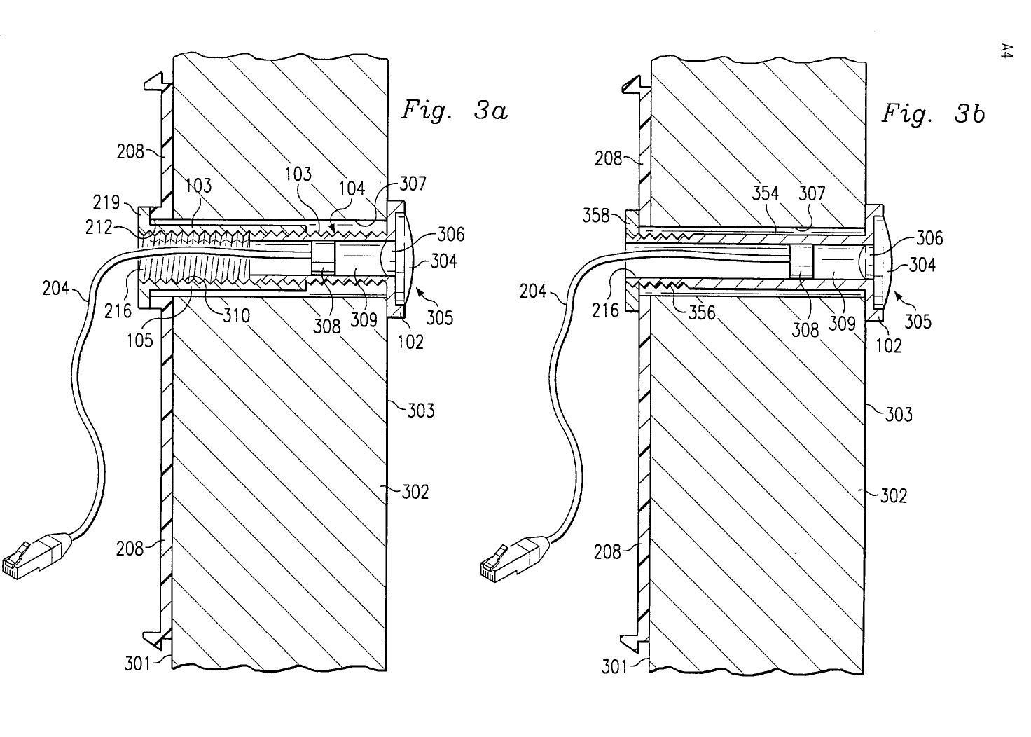

FIG. 3a illustrates one example of a mounting system for one embodiment of the present invention. The aspect illustrated in FIG. 3a is adapted to fit a variety of door thicknesses. FIG. 3a is a cross sectional view of the mounting plate 208 coupled to a door 302. The door 302 has a “first” or exterior side 303 and an “second” or interior side 301. A circular bore 307 runs from the exterior side 303 to the interior side 301. In the illustrative embodiment, the circular bore 307 could be an existing bore drilled for a conventional door viewer. Typically such bores are approximately ½″ to 1″ in diameter. In embodiments designed for individual apartment dwellers and renters, the renters could use the existing bores without damaging their landlord's doors. The conventional door viewer could then be easily re-installed when the renter moved.

In embodiments designed to fit a variety of door thicknesses, such as illustrated in FIG. 3a, the cylindrical unit 104 extends from the exterior side 303 into bore 307. The mounting unit 105 extends from interior side 301 through the mounting hole 212 of the mounting plate 208 into the bore 307. The screw threads 103 on the outer periphery of cylindrical unit 104 mates with female screw threads 310 on the interior surface of the mounting unit 105. The door 302 and the mounting plate 208 are positioned between the head 219 of mounting unit 105 and the lens holder 102 so as to fasten the combination to the door.

In some embodiments, the lens holder 102 has a lens system 305, which may comprise an exterior lens element 304 and an interior lens element 306 configured to provide a wide-angle exterior view. The lens 304 and 306 are shaped to focus and gather light onto an image pickup unit 308. However, in other embodiments, the lens system 305 may be configured in any number of conventional methods to provide different angles of view. Furthermore, any number of lens elements may be used depending on the quality and view of desired image. In this embodiment of the viewer 100, the lens focuses on persons relatively close to the door. Thus, the lens system does not need to be of the quality nor have the versatility of a the lens system in a conventional higher end digital camera. In fact, some embodiments may not need a lens system at all. The image gathered by the image pickup unit 308 could simply be focused and enhanced by digital processing.

The image pickup unit 308 may be typically located in a bore 309 of the cylindrical unit 104. The image pickup unit 308 may be a visible light image pickup unit, a low-light pickup unit (such as a green light unit), or a non-visible light image unit (such as a ultraviolet pickup unit). A non-visible light unit such as an ultraviolet pickup unit would allow the door viewer to operation in dark and low light conditions. Alternative embodiments have a non-visible light source, such as ultraviolet emitters, to provide a non-visible light source in totally dark conditions. The cable 204 is coupled to the image pickup unit 308 and run through the longitudinal opening 216 (FIG. 2) of the mounting unit 105.

Turning now to FIG. 3b, which illustrates another example of a mounting system. This example is similar to the system illustrated in FIG. 3a, except that a cylindrical unit 354 extends entirely through the bore 307 and past the mounting plate 208. An interior side end of the cylindrical unit 354 has exterior screw threads 356 for mating with a mounting nut 358. Thus, the door 302 and the mounting plate 208 are positioned between the nut 358 and the lens holder 102 so as to fasten the combination to the door. Optionally, a washer (not shown) may be installed between the nut 358 and the mounting plate 208.

In alternative embodiments, the lens system 305 and image pickup unit 308 could be replaced with a conventional bullet or miniaturized camera, available from such vendors as Sony, CSI/Speco, Watec and Weldex. Such a camera may be color, black/white, ultraviolet and of any processor including analog, digital, CCD or the like. In such embodiments, the cylindrical unit 104 or 354 may be modified to have hollowed section for the placement of such a camera. The camera may be sized to frictionally engage the side-walls of the cavity or be epoxied in position. The lens system 305 could then be simply replaced with a transparent lens cover.

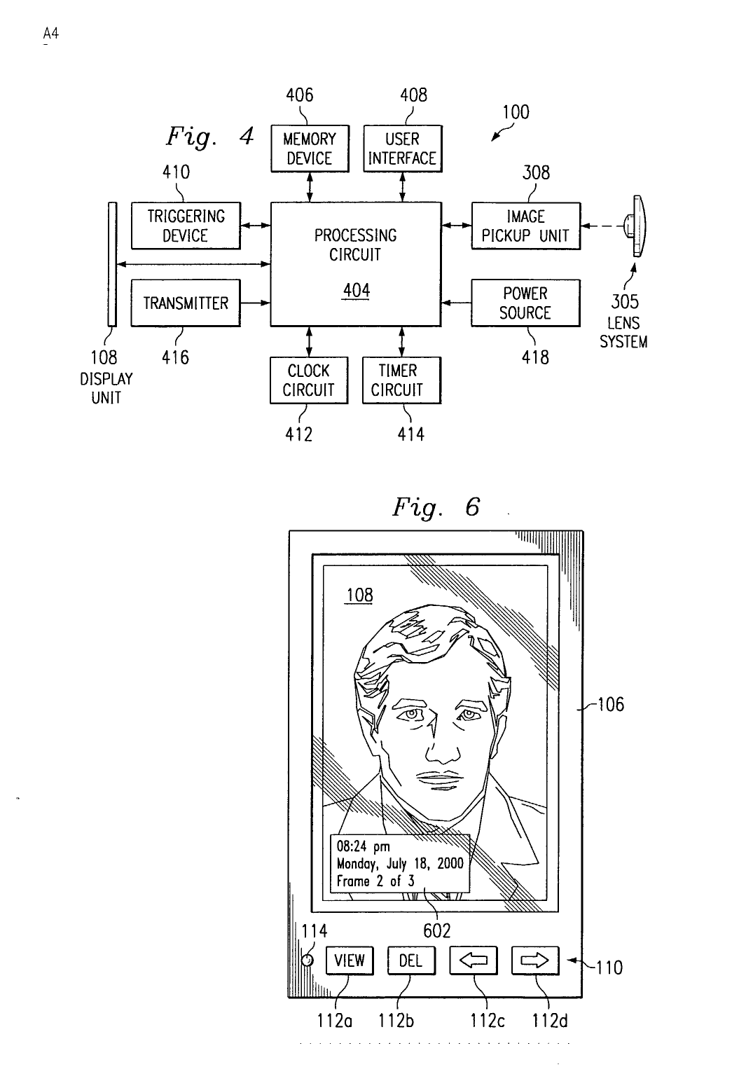

FIG. 4 is a simplified block diagram of one embodiment of the viewer 100 which provides a functional overview of the components which may be used in some embodiments. As previously discussed in reference to FIG. 3a, the lens system 305 focuses and gathers light onto an image pickup element of the image pickup unit 308. The image pickup unit 308 may use any type of image pickup element or light sensor, including charged coupled device “CCD” sensors or complementary metal oxide semiconductor “CMOS” sensors. For instance, a “higher end” embodiment may use a CCD sensor because a CCD sensor provides better resolution and works better in low light. A “lower end” embodiment may use a CMOS sensors, which would be acceptable when used in areas of having more light. A CMOS embodiment would have the additional advantage of using less power than an embodiment using a CCD embodiment. As previously discussed, other non-visible light sensors could also be used, such as infrared or ultraviolet sensors to allow the use of the door viewer in very low light conditions.

The image pickup unit 308 converts light signals into electrical output signals. The electrical output signals are sent to a control or processing circuit 404. The processing unit 404 transforms the electrical output signals into processed signals which can be displayed on the display unit 108 or stored in a memory device 406. In this embodiment, the processing unit 404 also controls the basic operations of the viewer 100. A user interface 408, such as the control panel 110 of FIG. 1, allows for user control and the input of preferences.

The processing unit 404 is also in communication with a triggering device 410. As will be explained in detail below, the triggering device 410 may be any number of devices, which upon an event (i.e, a “triggering event”), will cause the image pickup unit 308 to capture video signals and transform them into electrical signals. These electrical signals would then be processed by the processing circuit 404 and stored as a video image in the memory device 406 for later viewing by the user. Depending on the amount of memory storage in the various embodiments, such “video images” could both “still” graphic images or video motion images. Still pictures could be stored in a “raw” form or in a variety of “compressed” non-lossy or lossy data file formats, such as JPEG, GIF, TIFF, PNG formats. Similarly, moving pictures or videos could be stored in a variety of video formats, such as MPEG or similar formats. Thus, certain embodiments may allow for the recording and playing of video motion files of predetermined lengths. Such predetermined lengths could be user definable.

In some embodiments, a clock circuit 412 may also be coupled to the processing circuit 404. In other embodiments, the clock circuit 412 could be part of the processing circuit 404. The clock circuit 412 determines the time and date of triggering event so that the time and date may be stored along with the video image in memory device 406.

In some embodiments, there is a timer circuit 414 coupled to, or part of, the processing circuit 404. In other embodiments, such a circuit is a software routine running in the processing circuit 404 which extracts the time from the clock circuit. The timer circuit 414 allows the processing circuit 404 to measure the interval between triggering events and, as such, prevents the processing and storage of video images if the interval less than a predetermined amount.

Some embodiments of the viewer 100 also include a transmitter 416. The transmitter 416 may be either wired or wireless. If the transmitter is wireless, it may be a low-power radio transmitter, an infra-red transmitter, a PCMIA wireless network card, an 802.11a or 802.11b compatible transmitter, a “bluetooth” transmitter or some other wireless network transmitting device. Such a transmitter 416 may configured to automatically transmit images as they are being stored to a radio receiver, a network access point, or a wireless enabled storage device which may be part of a facility network (not shown). Such a wireless enabled storage device provides backup images. A backup storage device may be hidden (within or outside of the dwelling) so that if an intruder destroys the viewer 100, there is a record of the images stored by viewer 100. The storage device could also be coupled to an external network or a wireless home network. Such a wireless home network is disclosed in U.S. Pat. No. 6,282,714, which is incorporated by reference in its entirety.

For example, a condominium or apartment complex could maintain a central storage device which would record backup images for the entire building or complex. Alternatively, the images could be transferred via a network to a storage device that is accessible to security companies. Such images could be used in evaluating incoming alarm signals or viewed by police in the event of a crime.

A power source 418 provides electrical power to the processing circuit 404 and to the different components of the viewer 100. The amount of power necessary depends on the specific embodiment. For instance, in embodiments with relatively high power requirements, such as those using PIR motion detectors, communications transmitters, or large color displays, the power source 418 may be a rechargeable multi-cell battery pack or A/C power. In other embodiments, the power source could be a single AAA battery. Such power sources are widely known in the art. Additionally, there may be a secondary battery for maintaining a small amount of current to the processor and/or the memory device in the event of battery failure or removal.

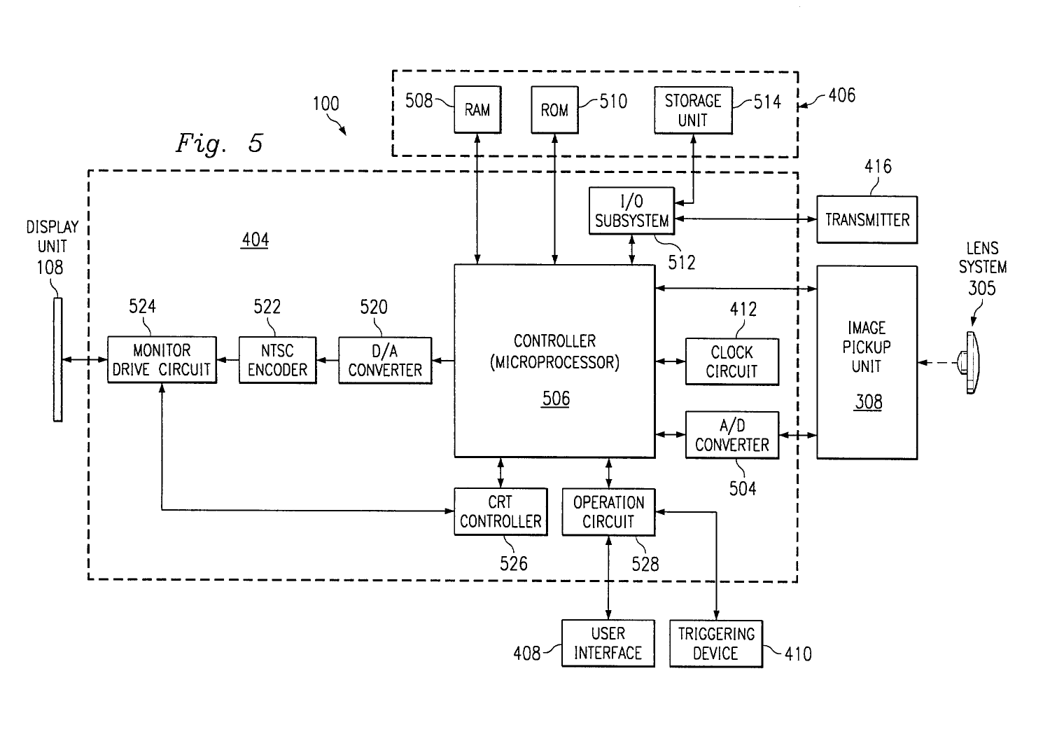

FIG. 5 is another functional block diagram showing additional detail of one embodiment of the processing circuit 404 and the memory device 406. As those skilled in the art will appreciate, FIG. 5 represents only one embodiment of the processing circuit 404. Many embodiments are possible and are within the scope of this invention. As previously discussed in reference to FIG. 4, the lens system 305 focuses and gathers light onto the image pickup unit 308. The image pickup unit 308 may have a image pickup circuit (not shown), which among other functions, controls the image pickup unit and a digital shutter (not shown). The digital shutter resets the image pickup unit before an image is taken so that the amount of light reaching the image pickup unit can be controlled. The image pickup circuit sends electrical signals to an analog-to-digital “A/D” converter 504, which in turn, converts the analog signals to digital signals and sends the digital signals to a microprocessor 506. In one embodiment, the A/D converter 504 may be a software routine residing in a memory unit, such as a read only memory “ROM” 510 coupled to the microprocessor 506. In another embodiment, the A/D converter 504 could be a separate A/D processor. Such A/D processors are well known in the art. In yet another embodiment, the lens system 305, the image pickup unit 308, and the A/D processor 504 could be a miniature bullet camera as previously described. Regardless of the embodiment, digital signals are sent to the microprocessor 506 for processing and storage upon a triggering event.

In the illustrative embodiment, the microprocessor 506 controls the basic operations of viewer 100. Such operations could include compressing the digital signals before storing the signals as file images. The microprocessor 506 is coupled to a memory device 406, such as random access memory “RAM” 508. The RAM 508 may be used for the temporary storage of data used in processing signals and the operation of viewer 100. In some embodiments, the microprocessor 506 reads instructions, such as processing and operating logic from a set of read-only memory “ROM” 510. In other embodiments, ROM 510 could be flash memory or another non-volatile form of memory and the microprocessor 506 may be one or more processors or circuits.

In this embodiment, the microprocessor 506 also exchanges data with an input/output or I/O subsystem 512. I/O subsystem 512 may be a data bus coupled to a USB host controller. If a USB host controller is not used, I/O subsystem may contain one or more ports for communicating with a number of electronic devices, such as an image storage unit 514 or the transmitter 416.

The storage unit 514 stores images for later viewing. Additionally, the storage unit stores time/date information from the clock unit 412. The storage unit 514 may be any of a number of storage devices, including flash memory, a smart media card, a compact flash card, or even a small hard disk such as a PCMCIA hard disk card or a microdrive (available from IBM). All such devices may be part of the memory device 406 (FIG. 4).

In the illustrative embodiment, the microprocessor 506 is also coupled to a digital-to-analog “DIA” converter 520. When it is desired to display the digital signals or a stored image from storage unit 514, the stored digital image may be temporarily stored the RAM 508. The digital image signals (image data) may be then be uncompressed and converted into analog signals through the D/A converter 520. The analog signals may be input to an encoder 522, such as a National Television Standards Committee (“NTSC”) encoder. The encoder 522 converts the input analog signals into NTSC (standard) type television signals (video signals) in accordance with the luminance signals (Y) and chroma signals (C) of the input analog signals and synchronizing signals input from a synchronizing signal generating circuit (not shown). The generated NTSC television signals are then output from the encoder 522 and input to a monitor drive circuit 524. The monitor drive circuit 524 drives the display 108, such as a LCD monitor, to display digital images (reproducing images) thereon in accordance with the NTSC television signals input from the encoder 522. In other embodiments, the display 108 could be a digital display, and thus could receive the digital signals directly.

A CRT controller 526 may control additional, predetermined information to be displayed on display 108 in additional to the actual image file. The CRT controller 526 retrieves the predetermined data, which may correspond to the date, time, frame number, frame total or other information to be indicated on the display 108. In some embodiments, such information may be stored in separate data files along with the image data in storage unit 514. The predetermined image signals may be drawn from the memory in the CRT controller 526 in accordance with appropriate command signals from the microprocessor 506, so as to input the predetermined image signals to the monitor drive circuit 524. The monitor drive circuit 524 may drive the display 108 to indicate the numeral, symbol(s) and/or message on the display 108 in accordance with the image signals received from the CRT controller 526. The predetermined data representing the frame number “N”, date, time, and frame total may be superimposed on an image (subject image) indicated on the display 108 when image is reproduced.

An operation circuit 528 may also be coupled to microprocessor 506. The operation circuit may control the signals from the user interface 408 and the triggering device 410.

Referring now to FIG. 6a, there is a front view of one embodiment of the viewer 100. As discussed previously, there is the housing 106, the display 108, and the control panel 110 in the illustrative embodiment. The control panel 110 comprises the control buttons 112a through 112d and LED 114. The button 112a is labeled “View;” the button 112b is labeled “Del” for delete, the button 112c is labeled with a backward arrow, and the button 112d is labeled with a forwards arrow. Note that the embodiment shown in FIG. 5 illustrates only one of many various button-screen layouts. Many more button layouts and screen combinations are possible. In fact, no buttons are needed if the display unit 108 is a touch sensitive flat panel display.

Operation of One Embodiment

The operation of one aspect will now be discussed with reference to FIGS. 4 and 5. The viewer 100 takes a video image or “picture” in response to a triggering of the triggering device 410 or as a result of a user command via the user interface 408.

Once “triggered” the triggering device 410 sends a “triggering” signal to the processing circuit 404. In the case of the embodiment illustrated by FIG. 5, the triggering signal would be received by the operational circuit 528. Once the operational circuit 528 receives the triggering signal, the microprocessor 506 instructs the image pickup circuit to reset the image pickup unit 308. The microprocessor then takes a reading of the available light. The microprocessor 506 then determines the shutter speed and instructs the image pickup circuit to reset the image pickup unit 308. Because the viewer 100 may be typically attached to a door, the viewer 100 will not suffer from “camera shake” as conventional digital cameras. Consequently, the shutter speed may be slightly longer than in conventional handheld devices without adversely affecting the image quality. Additionally, the processor may “white balance” the image. “White balance” refers to processing routines which correct color, tint, and contrast, to correct for different lighting conditions. Such processing and long shutter speeds enables the use of the viewer in relatively low light conditions.

The image pickup unit 308 is then reset and exposed to the light until the shutter (not shown) closes. The A/D converter 504 measures the electrical charge on the light sensor and creates a digital signal that represents the values of the charge at each pixel of the image pickup unit 308. The digital signal is then sent to the microprocessor 506 for image processing and, optionally, compression. If the triggering signal was in response to a command from a user interface, such as the control panel 110, the processed image is also sent to the D/A converter 520 for display on the display unit 108. In any case, the compressed signal will be stored in storage unit 514, along with other predetermined data, such as frame number, time, and date. In some embodiments, the compressed signal will also be sent to the transmitter 416 so that a backup image can be sent to a network or a backup storage device. Each set of digital signals may be stored as a file in the data storage unit. In some embodiments, software coupled to microprocessor 506 may manage the files in a first-in, first-out (“FIFO”) manner. However, if there is not enough room on the storage unit 514, the earliest files may be deleted to make room for the later files. Thus, there may be a record of the last visitor triggering a shutter signal, regardless of the available storage capacity.

Referring back to FIG. 6. Once an image has been stored as a result of a triggering event that is not from the user interface 408 (such as control panel 110), the LED 114 may blink at a predetermined interval. This blinking of LED 114 will notify the user that there is an unviewed image stored in the door viewer. In the embodiment illustrated in FIG. 6, the user may then press button 112a to view the most recent image stored in storage unit 514. As previously discussed, other predetermined data 602 may also be displayed with the image, such as the time and date that the image was taken. Additionally, the frame or image number may also displayed. The total number of stored images in memory may also be displayed to let the user know that there may be other images available to be viewed and the amount of memory left in the storage unit 514. Pressing a “delete” button, such as control button 112b allows the occupant to delete the currently viewed image from display. The next most recent image will then be displayed. Pressing the delete button will also signal the software running on microprocessor 506 to “free” up the storage space used by the current image.

If the occupant does not wish to delete the current image, the occupant may view the stored images by pressing either button 112c or 112d. The button 112d advances the images displayed on the screen. The button 112c allows the occupant to backup and view previously viewed images.

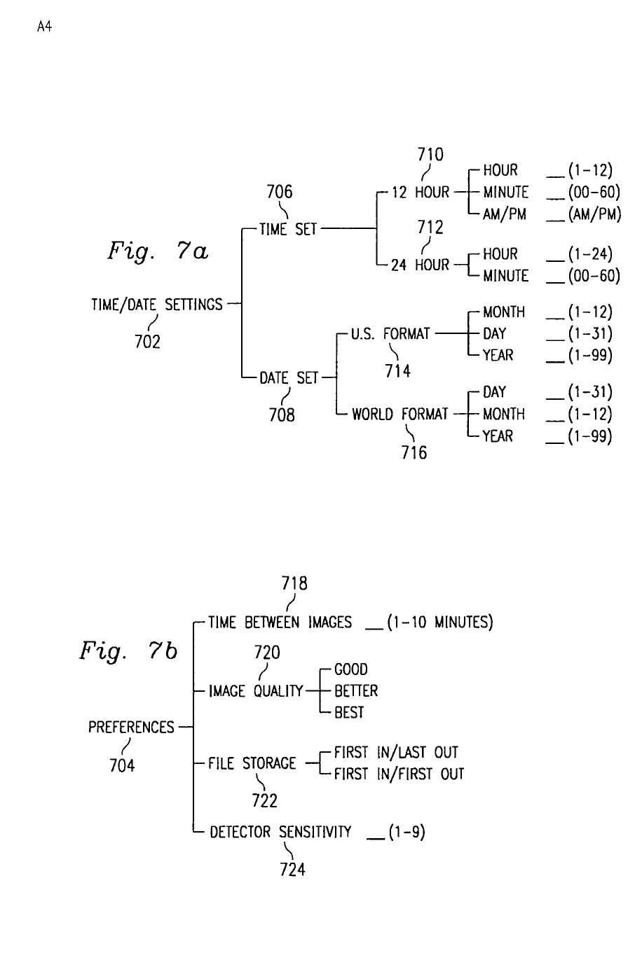

The control buttons 112a through 112d may also be used to set user preferences, the time, and date. Pressing a particular button or combination of buttons for a predetermined length of time, such as three seconds, could put the unit is a “set mode” allowing the occupant to set the date and time by advancing the arrow buttons 112c and 112d. One example embodiment of a menu structure for setting time, date, and preferences is illustrated in FIGS. 7a-7b. For example, if the user pressed control buttons 112c and 112d for three seconds, a set menu would appear on the display 108. The initial menu might have two choices: a time/date choice 702 (FIG. 7a) and a preferences choice 704 (FIG. 7b). Each choice could then have selections or sub-choices. For example, the user could set the time with a time menu 706 and set the date with a date menu 708. Within the time menu 706, the user could select between displaying the time in a 12 hour mode with a 12-hour choice 710 or in a 24 hour mode with a 24-hour choice 712. Either way, the user could then set the initial time. With the date set choice 708, the user could choose between setting the date with a U.S. format choice 714 of month/day/year or a international standard choice 716 of day/month/year.

Similarly, the user could specify preferences by selecting a preference menu 704, such preferences may be a minimum allowable time interval choice 718 (e.g., the minimum time interval between storing images), an image quality choice 720, an image storage procedure choice 722 (such as FILO or FIFO), or a triggering device sensitivity choice 724.

The Triggering Device:

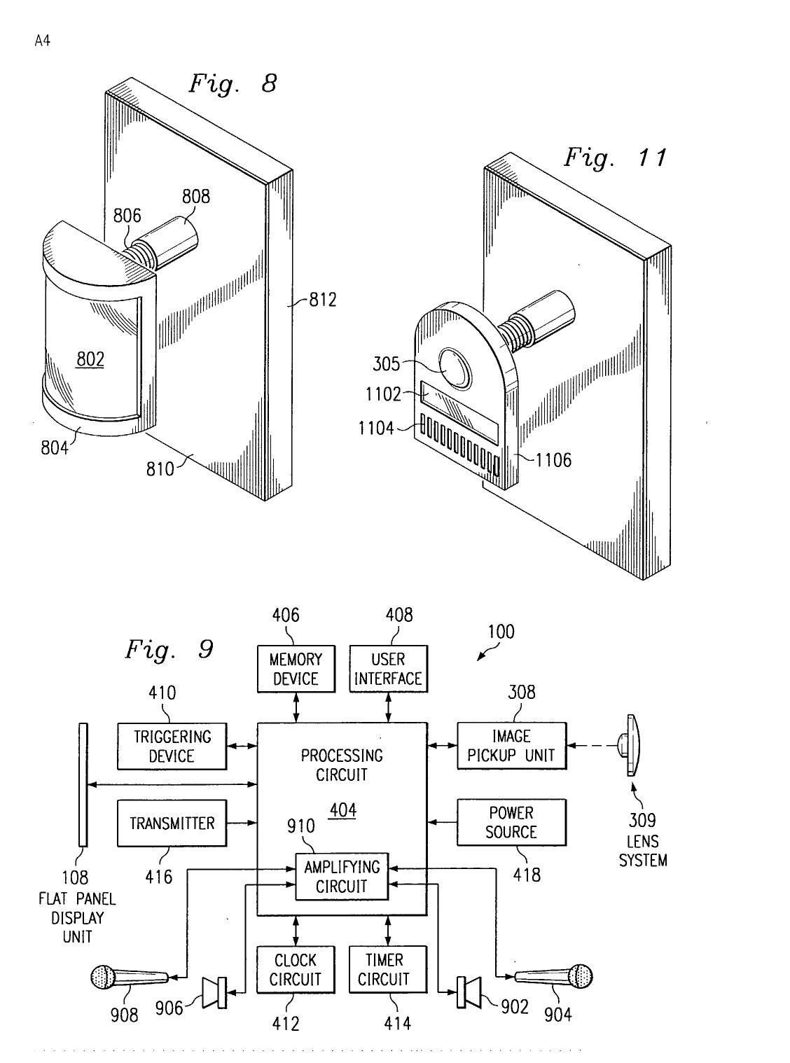

As previously discussed, the present invention could be coupled to a variety of triggering devices. For example, one such triggering device could be a motion detector. FIG. 8 illustrates one such embodiment as viewed from the front or “exterior” side, using a passive infrared “PIR” motion detector. However, any type of motion detector could be used including light, laser, ultrasonic, or microwave detectors.

In the illustrative embodiment, a transparent lens or sensor cover 802 may be coupled to a sensor housing 804. The sensor housing 804 may be made of molded plastic, PCB, or another suitable material. The sensor housing may be coupled to a cylindrical unit 806, which is similar to the cylindrical unit 104 of FIG. 1. The cylindrical unit 806 screws into a mounting unit 808, which is similar to the mounting unit 105 of FIG. 1. The mounting unit 808 is coupled to a mounting plate 810. The mounting plate 810 is similar to the mounting plate 208 of FIG. 2. The mounting plate 810 couples to an enclosure 812. The enclosure 812 houses the electronic circuits of this embodiment and a panel display (not shown).

The embodiment illustrated in FIG. 8 mounts to a door in a manner similar to that illustrated by FIG. 3a or 3b. Once mounted, the door therefore is sandwiched between the sensor enclosure 804 and the mounting plate 810. In the illustrative embodiment, the sensor housing 804 encloses a visual lens system (not shown), similar to the lens system 305. In some embodiments, the sensor housing 804 could also house a digital camera, and thus eliminating the need for mounting the camera in the cylindrical unit 806.

In the illustrative embodiment, the sensor housing 804 also encloses the PIR or pyroelectric sensor (not shown). A PIR sensor detects changes in infrared radiation or heat energy, caused for example, by a outsider. PIR sensors typically have a lens that focuses heat energy rearward toward a focal point and a PIR sensing element. An internal chamber created between the sensor cover 802 and the sensing element is kept substantially vacant to allow heat energy to be directed toward a sensing element. Such PIR sensors are widely known in the art. One such sensor designed to be battery operated is disclosed in U.S. Pat. No. 5,790,040, which is incorporated by reference in its entirety. As previously discussed, once the PIR detects significant motion, the PIR signals the processing circuit 404, which causes an image to be stored in the memory device 406.

An outsider approaching the door would generate a significant amount of movement for a period of several seconds to as long as a few minutes. Such movement would cause the unwanted storage of hundreds of still images. To remedy this situation, the timer circuit 414 would measure the time interval between the last storage of an image. The viewer 100 would be programmed so that the images would not be stored at less than predetermined time intervals. Such a time interval could be user selectable, and for example, could vary from 5 seconds to 2 minutes. Thus, the use of timer circuit 414 would prevent the unwanted storage of numerous images every time movement from an outsider occurred. Such timer/clock circuits are well known in the relevant art.

In other embodiments, the triggering device 410 could be a radio receiver. Such a radio receiver may be set to receive radio signals from a variety of actuating devices, such as radio controlled door bells, motion detectors, touch sensitive door mats, vibration detectors or any combination of the these devices. For example, in areas of heavy traffic, such as apartments with common hallways, it might be preferable to capture images only when the door bell is rung. In such an embodiment, the door bell could be coupled to a radio transmitter. The door viewer would then be coupled to a radio receiver. When the doorbell is pressed, an RF signal is sent by the transmitter to the radio receiver, which signals the processing circuit 404, causing an image to be stored in the memory device 406. A radio control doorbell system is disclosed in U.S. Pat. No. 4,523,193, which is herein incorporated by reference.

In yet other embodiments, the radio receiver could receive signals from motion detectors installed in front or near the door. Such embodiments would allow for a less conspicuous configuration. In this configuration, a radio transmitter transmits an RF signal to the radio receiver coupled to the door viewer 100. The RF signal would be in response to the actuation the motion detector. Once the RF signal is received, the radio transmitter signals the processing circuit 404, which causes an image to be stored in the memory device 406.

The door viewer could also be configured to act as a wireless network node or coupled to a wireless network card, such as a wireless PCMIA card. The radio receiver could then receive signals from motion detectors configured to operate as network devices in a wireless network.

In other embodiments, the triggering device could be software or firmware running in the processing circuit 404 or a similar processing unit. In such an embodiment, the image pickup unit 308 could generate a still image or frame of the viewed area periodically, for instance, once every 5 seconds. It could then compare the most recent frame to a previous frame to determine if the number of pixel differences. If the number of pixel differences exceeds a predetermined number, for instance 40 percent, the software routine would determine that signification motion has occurred. The processing circuit 404 would then cause the last image to be stored in the memory device 406. Such software routines are described in U.S. Pat. Nos. 5,602,585 and 6,014,183, which are incorporated by reference.

Additional Aspects:

The door viewer 100 could also be coupled to an intercom system. Such a system would allow the user to communicate with the outsider without opening the door. Referring now to FIG. 9, there is presented a functional diagram of another embodiment of the door viewer coupled with a self-contained intercom system. FIG. 9 shows the same components as FIG. 4 with the inclusion of an external speaker 902, an external microphone 904, an internal speaker 906, an internal microphone 908, and a audio processing or amplifying circuit 910.

The external speaker 902 and internal speaker 906 could be conventional speakers, flat panel speakers, or digital speakers. In any case, such speakers would be relatively small. The external microphone 904 and the internal microphone 908 could be any type of conventional microphone, including carbon, crystal, dynamic, ribbon or condenser. Such microphones may also have the appropriate microphone amplifying circuits and filters, as known in the art.

In some embodiments, the amplifying circuit 910 could be a separate amplifying circuit or incorporated into the processing circuit 404, as illustrated in FIG. 9. Furthermore, the amplifying circuit could be an analog circuit or a digital circuit. If a digital circuit is employed, it may contain at least one digital signal processing (“DSP”) chip, an A/D converter and a D/A converter.

In an embodiment that uses analog half-duplex circuitry, a user could activate the internal microphone 908 and speak into the microphone 908. The microphone 908 converts the acoustic energy from the speakers voice to electrical signals. These signals are amplified by the amplifying circuit 910 in a conventional manner and transmitted to the external speaker 902, thus allowing the outsider to hear the user. The user can respond by speaking into the external microphone 904. The external microphone 904 converts the acoustic energy into electrical signals, which are amplified by the amplifying circuit 910, and transmitted to the internal speaker 906. The user, therefore, does not have to open the door to carry on a conversation with the outsider.

In other embodiments, the internal microphone 908 and internal speaker 906 could be combined into a small single speaker. Additionally the external microphone 904 and the external speaker 902 could be combined into a single small speaker. Because speakers are essentially the opposite of microphones (i.e., they convert electrical energy back to sound pressure), small speakers can be used as a low quality dynamic microphone in half-duplex circuits. Such speakers are well known in the art.

In another embodiment, a full duplex circuitry could be employed. Full duplex circuitry would allow the simultaneously transmission of audio signals in both directions (i.e., it can simultaneously transmit and receive audio signals). This allows for a more natural conversation. In order for a full duplex circuit to avoid undesirable audio feedback, a sophisticated process of adaptive echo cancellation using a DSP chip may be required. As is known in the art, such a circuit would utilize a pair of coder-decoders (CODECs) to process the audio signals provided via the two microphones 904 and 908. Each CODEC contains an analog-to-digital (A/D) converter and a digital-to-analog (D/A) converter. The first CODEC, for instance, may be coupled to one microphone 904 and its associated A/D converter digitizes the audio signals provided by the microphone 904 so that they can be processed before being sent to the speaker 906. The second CODEC is coupled to the microphone 908. Its associated A/D converter digitizes the audio signals provided by the microphone 908 so that they can be processed before being sent to the speaker 902. The D/A converter of the first CODEC converts digitally processed signals originating from the microphone to analog signals so that they can be transmitted by the speaker 906. The D/A converter of the second CODEC converts the digitally processed signals originating from the microphone 904 to analog signals so that they can be transmitted by the speaker 906. Each of the first and second CODECs may also include two filters (one coupled to each input and output) to remove high frequency noise so as to avoid aliasing.

In another embodiment using a digital circuit, audio information in addition to video data may be stored and retrieved by the door viewer. This embodiment would allow an outsider to leave a video and audio “message” for the user. Refer back to FIG. 9. In this embodiment, upon activation of the triggering device 410, the external microphone 904 sends electrical signals to a A/D circuit. The A/D circuit converts the analog signals to digital signals. The A/D circuit sends the digital signals to a DSP chip for processing. The DSP performs some filtering and then sends the processed signals to the processing circuit 404. Simultaneously, the image pickup unit 308 is also sending video signals to the processing circuit 404. The processing circuit 404 may then store the video and audio signals in the memory device 406. The signals may be stored separately or be combined, for instance, in a MPG format.

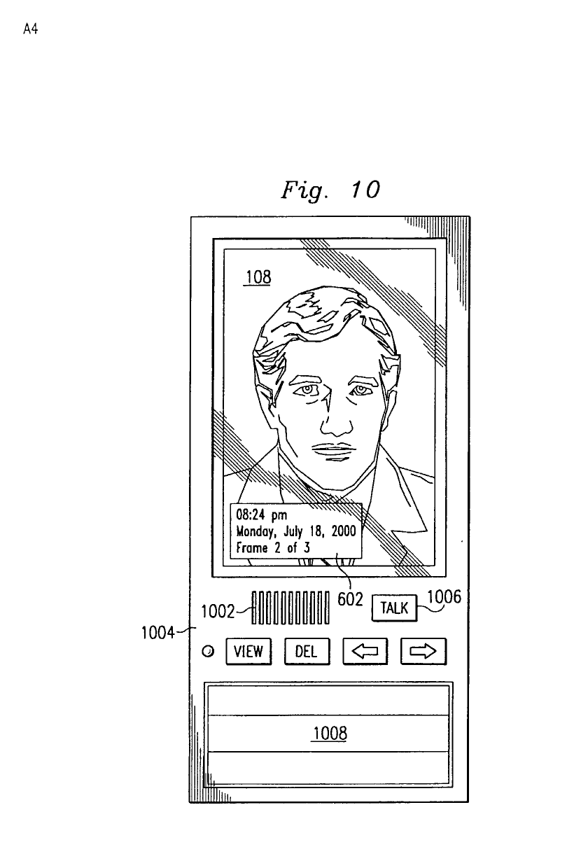

FIG. 10 is an interior view of one embodiment of the present invention having an intercom circuit. The components of FIG. 10 are similar to those described with reference to FIG. 6. However, this embodiment has a grill 1002 for allowing acoustic energy to pass through the housing 1004 to the microphone 908 (FIG. 9). The grill 1002 also permits acoustical energy to travel from the speaker 906 (FIG. 9). If the user wishes to talk to an outsider, the user can simply press the control button 1006, which will activate the intercom circuit. This embodiment also has a rechargeable battery pack 1008, which is easily removable by conventional means. This embodiment could be packaged with two rechargeable battery packs and a separate AC battery pack charger. Such a kit will allow for the one battery pack to be charged while the other is in use. Furthermore, the power source would also include a back-up battery which would provide enough power to preserve the contents of the memory when the primary battery is removed or discharged.

FIG. 11 is an exterior view of one embodiment of the present invention having an intercom circuit. The components of the embodiment illustrated in FIG. 11 are similar to those described with reference to FIG. 8. However, this embodiment has a smaller motion sensor (not shown). There is illustrated the lens system 305, a lens cover 1102 for the motion sensor, and a grill 1104. As discussed with reference to FIG. 10, the grill 1104 permits acoustical energy to pass through the exterior enclosure 1106. In this embodiment, the exterior enclosure 1106 houses the motion sensor, the lens system 308, the external speaker 902, and the external microphone 904. The exterior enclosure 1106 may be of any aesthetically shape, with a sufficient depth to allow the operation of the motion sensor.

In another embodiment, a door viewer as described above could be integrated into a door. Such a door could be used in new construction or remodeling. In such an embodiment, electrical power wires run either vertically or horizontally through the door to contact points at the edge of the door. The door contact points would be coupled to contact points in the door frame, which are connected to power wires. Thus, the door viewer would run from AC power. In this embodiment, the door could contain an AC to DC power converter, and a small rechargeable battery or capacitor to prevent the door viewer from losing files stored in the memory device 406. Such converters are well known in the art. In other embodiments, the door viewer would contain a charging circuit to charge the primary battery. In yet other embodiments, the edge of the door contains an electrical coil and the door frame also contains an electrical coil. When the two coils are proximate to each other, such as occurs when the door is closed, an inductive current can be created to charge the battery of the door viewer. Such an inductive charging circuit within the door eliminates the need for power wires running through the door jamb. Inductive charging circuits are well known in the art.

If not equipped with a wireless transmitter as previously discussed, the door could also have network cables running through it designed to pass from the door through the hinge and into a wired system of the building. Furthermore, the display unit could be flush or slightly recessed relative to the door surface. Thus, the viewer could be hidden from view by a swinging or sliding door panel.

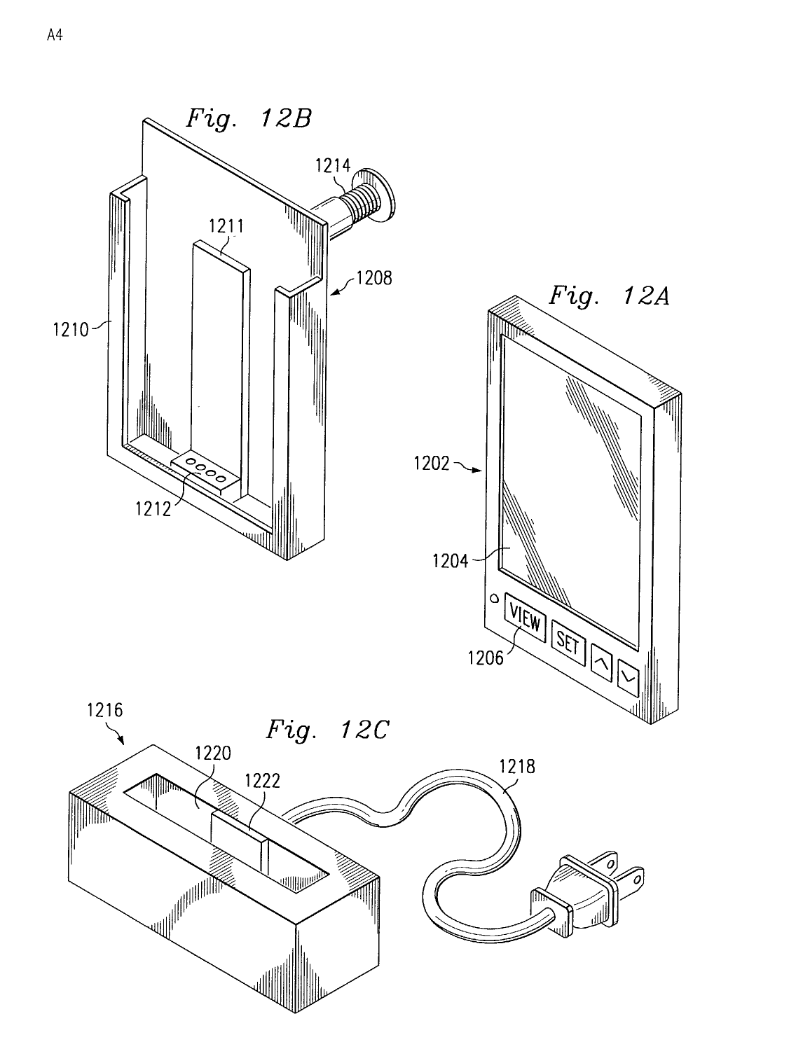

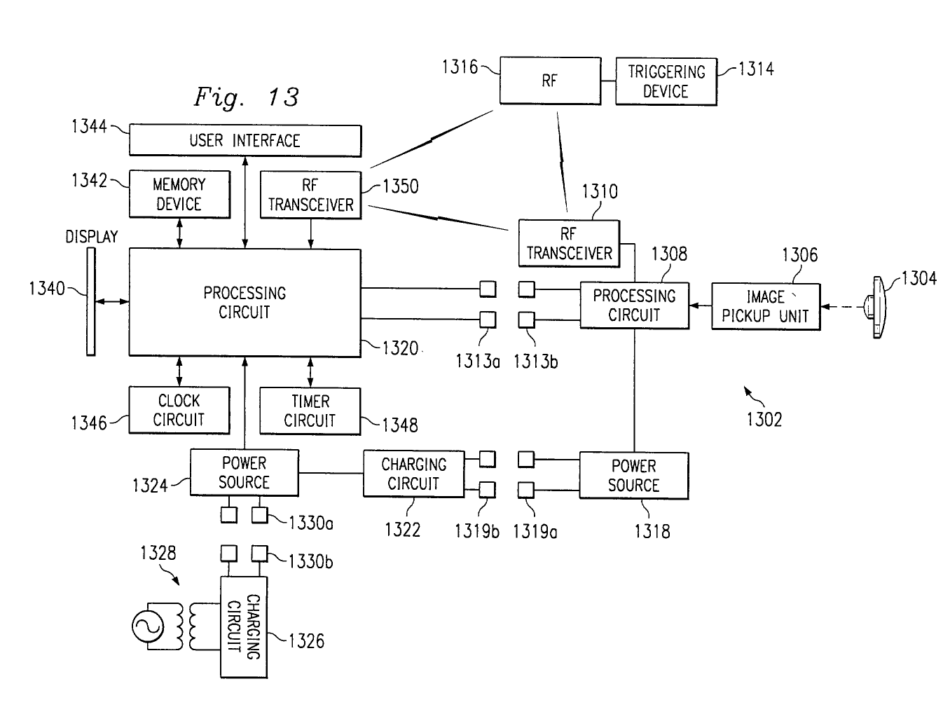

Another embodiment comprises a modular component system. Such a modular component system 1200 is illustrated in FIGS. 12a through 12c. Turning now to FIG. 12a, the first modular component may comprise a display module 1202. The display module 1202 houses a display 1204 and user interface 1206 which similar to displays and user interfaces described previously. The display module 1202 may be adapted to couple with a mounting unit, which is secured to a door.

FIG. 12b illustrates one embodiment of a mounting unit 1208. In this embodiment, the mounting unit 1208 comprises a mounting sleeve 1210. The display module 1202 may be adapted to slidingly fit within the mounting sleeve 1210. Electrical contacts (not shown) on the back side of the display module 1202 may make contact with electrical contacts 1212 of the mounting unit 1208. As will be explained in greater detail below, the electrical contacts 1212 allow current to flow between a first battery (not shown) in the display module 1202 and a second battery (not shown) in the mounting unit 1204. As will be described below, the mounting unit 1212 may also house an image gathering device positioned within a cylindrical unit 1214. A rib 1211 projects into the mounting sleeve 1210. The rib 1211 may house electrical connections leading from the electrical contacts 1212 to the image gathering device and/or power source for the mounting unit. The rib 1211 may be adapted to slidingly fit within a groove (not shown) on the back of the display unit 1202, which could also assist in aligning the electrical contacts 1212 with the corresponding electrical contacts on the display module 1202.

Alternatively, the mounting unit could also be coupled to a motion detector, another other triggering device, a microphone, and speaker as described previously. The mounting unit 1212 may mount to a door in a similar manner to the previously described embodiments.

A third component may be a charging unit adapted to charge a battery in the display module 1202. One example charging unit 1216 is illustrated in FIG. 12c. The charging unit 1216 may be adapted to couple with electrical connectors (not shown) on the back of the display module 1202. As is widely known in the art, the charging unit 1216 has a power cord 1218 to couple with an electrical wall outlet. The charging module has a slot 1220 which is adapted such that a bottom portion of the display module 1202 can slidingly fit within the slot 1220. On embodiments where a alignment rib 1211 is used, the slot 1220 would also have a rib 1222 to fit within a corresponding groove on the display module 1202. As will be explained below, when the display unit 1202 is inserted into the slot 1220, electrical connections (not shown) on the display unit 1202 couple to electrical connections in the slot 1220 such that a power source or battery in the display unit can be charged.

Turning now to FIG. 13, there are example functional block diagrams which could be employed in the modular components described in reference to FIGS. 12a 12c. A functional block diagram 1302 represents one embodiment of the mounting unit 1208. The illustrated embodiment has a lens system 1304, which is similar to the lens system 305 described above. The lens system 1304 focuses light onto an image pickup unit 1306, which is similar to the lens pickup unit 308, described above. The image pickup unit sends electrical signals to a processing circuit 1308. The processing circuit 1308 controls the operation and functions of the mounting unit 1208. The processing circuit 1308 may be in communication with a processing circuit 1320 located in the display module 1202 through a radio frequency transmitter or transceiver 1310. The transceiver 1310 may be any suitable wireless transmitter, including a low-power radio transceiver, an optical transceiver, a PCMIA wireless network card, an 802.11a or 802.11b compatible transceiver, a “bluetooth” transceiver, or some other wireless network transmitting and receiving device.

Alternatively, when the display module 1202 is physically coupled to the mounting unit 1208, the processing circuit 1308 may communicate with the processing unit 120 through a plurality of electrical connections 1313b, which couple to electrical connectors 1313a of the display module 1202. In some embodiments, the processing unit 1308 may also be in communication with a triggering device 1314 via a wired or wireless communication paths. Thus, the triggering device may either be in wired communication with the processing unit 1308 or in wireless communication with the processing circuit through a radio frequency transceiver 1316. If in wired communication, the triggering device 1314 may be housed within or coupled to the mounting unit 1208. On the other hand if the triggering device is wireless, it may be an independent device, such as a door bell.

In the illustrative embodiment, the mounting unit 1208 has an independent power source 1318. Such a power source may be a rechargeable battery, as is well known in the art. In some embodiments, the power source 1318 is connected to electrical connections 1319a. The electrical connections 1319a couple with electrical connections 1319b when the display module 1202 physically coupled to the mounting unit 1208. The electrical connections 1319b are connected to a charging circuit 1322 which may be housed in the display module 1202. Thus, when the display module 1202 is coupled to the mounting unit 1208, the display module may charge the power source 1318 of the mounting unit 1208.

The charging circuit 1322 draws electrical power from a power source 1324, which in addition to supplying power for the charging circuit 1322, provides power for the rest of the components of the display module 1202. The power source 1324 couples to a charging circuit 1326, which in the illustrative embodiment is located in the charging unit 1216. The charging unit 1216 also comprises a AC to DC transformer 1328 to provide DC current from an AC power source. Such transformers are widely known in the art. The charging circuits 1326 and 1322 may also comprise a processing circuit (not shown) to control and regulate the charging of the power source 1324 and 1318, respectively. Such regulation may be necessary in order to prevent damage to the power source 1324.

The charging circuit 1326 may provide power to the power source 1324 through electrical connectors 1330a, which couple to electrical connectors 1330b. The electrical connectors may connect to the power source 1324. Alternatively, the charging circuit may also be an inductive charging circuit as previously described. An inductive charging circuit would eliminate the need for the electrical connectors 1330a and 1330b and be partially housed in both the charging module 1216 and the display module 1208.

The processing circuit 1320 is similar to the processing circuit 404 discussed above. In the illustrative embodiment the processing circuit is coupled to a display 1340, a memory device 1342, a user interface 1344, a clock circuit 1346, and a timer circuit 1348. Such components may be similar to the display 108, the memory device 406, the user interface 408, the clock circuit 412, and the timer circuit 414, respectively.

The processing circuit 1320 may also be coupled to a transceiver 1350, which is adapted to wirelessly communicate with the transceiver 1310 of the mounting module 1208. In alternative embodiments, the transceiver 1310 also receives signals from the transmitter 1316, which is coupled to the triggering device 1314.

In additional embodiments, the mounting module 1208 and the display module 1202 may be equipped with microphones, speakers and amplifying circuits as described in reference to FIG. 9, such an embodiment allows the user to conduct conversations without opening the door.

In operation, the user can charge the power source 1324 of the display module by inserting the display module 1202 into the charging slot 1220 of the charging module 1216. Once the display module has been sufficiently charged, the display module 1202 may be inserted into the mounting sleeve 1210 of the mounting unit 1208. As previously discussed, the power source 1324 of the display module can then be used to charge the power source 1318 of the mounting module 1208. Control circuits or processors, which may be part of the charging circuits 1322 and 1318 prevent the power sources 1324 and 1318 from being overcharged. Such control circuits and processors are widely known in the art.

When both power sources 1324 and 1318 are sufficiently charged, the user may operate the display module 1202 similar to previous embodiments. However, the user has the option of removing the display module 1202 from the door and keeping the display module 1202 in close proximity to the user. Thus, when someone approaches the door when the user is at home, the user can be notified and determine who is at the door via the display module without having to approach the door.

In sum, the present invention has several substantial advantages over the prior art. Among other features, it provides a visual record of who visited the door without having to install an elaborate security system. A user can see who is at the door without the knowledge of the outsider. Other aspects allow a user to clearly communicate with an outsider without having to open the door.

Although the invention has been described with reference to specific embodiments, these descriptions are not meant to be construed in a limiting sense. Various modifications of the disclosed embodiments, as well as alternative embodiments of the invention or combinations of embodiments will become apparent to persons skilled in the art upon reference to the description of the invention. It is therefore, contemplated that the claims will cover any such modifications or embodiments that fall within the true scope of the invention. For instance, in one embodiment, the door viewer could comprise: an image sensor adapted for receiving video input signals from a first side of a door and converting the video input signals into output signals; a processing circuit in communication with the image sensor, wherein the processing circuit is adapted for processing the output signals into processed signals; a display in communication with the processing circuit, wherein the display is adapted to be viewable from a second side of the door; and an actuating device in communication with the processing circuit, such that upon activating the actuating device, the processed signals are displayed in the form of an image on the display.

Yet another embodiment could comprise a digital camera adapted to be mounted in a door such that the digital camera receives at least one image from a first side of a door; a control circuit in electronic communication with the digital camera, wherein the control circuit is adapted for processing signals from the digital camera, a display in communication with the control circuit, an enclosure for housing the display and control circuit, the enclosure adapted for coupling to a second side of the door such that the display is viewable from the second side of the door; and an actuating device in communication with the control circuit, such that upon activating the actuating device, signals from the digital camera are processed by the processing circuit and displayed on the display.

Additionally, another embodiment could a door having a camera barrel adapted to be mounted inside a door for enclosing an image sensor, wherein the image sensor is adapted to receive video images from a first side of the door; a interior mounting panel coupled to the camera barrel, wherein the mounting panel is positioned on a second side of the door; an enclosure coupled to the mounting panel; a processing circuit positioned within the enclosure and in communication with the image sensor; a display positioned within the enclosure and in communication with the processing circuit, such that the display is viewable from the second side of the door.

Any of the above embodiments could also include a memory device in communication with the processing circuit, wherein the memory device is adapted for storing the processed signals; a triggering mechanism in communication with the processing circuit such that when the triggering mechanism is triggered, the processed signals are stored in the memory device; a timer circuit in communication with the processing circuit to measure an interval between triggering events, such that storing of the processed signals is prevented if the interval is less than a predetermined value, wherein the triggering mechanism may be a motion detector, circuitry adapted for determining motion coupled to the processing circuit, a radio receiver, or a user interface; and a clock circuit in communication with the image processing circuit to determine the time and date of the triggering of the triggering mechanism.

Any of the above embodiments could also include: an amplifying circuit; a first microphone positioned to receive audible signals from the first side of the door, wherein the first microphone is in communication with the amplifying circuit; a first speaker in communication with the amplifying circuit and positioned on the second side of the door, a second microphone positioned to receive audible signals from the second side of the door, wherein the second speaker is in communication with the audio processing circuit, and a second speaker in communication with the amplifying circuit and positioned on the first side of the door.

Alternatively, any of the above embodiments could include a memory device, an audio processing circuit in communication with the first microphone and the memory device, wherein the audio processing circuit is adapted for processing output signals from the microphone such that the processed signals may be stored in the memory device, a user interface in communication with the audio processing circuit, wherein upon actuating the user interface, the processed signals stored in the memory device are sent to the amplifying circuit and played over the first speaker.

Additional embodiments could also include an amplifying circuit in communication with the processing circuit, a first speaker in communication with the amplifying circuit, wherein the first speaker is positioned on the first side of the door and the first speaker is adapted for receiving audible signals from the first side of the door and converting the audible signals from the first side of the door into electrical signals, and a second speaker in communication with the amplifying circuit, wherein the second speaker is positioned on the second side of the door and the second speaker is adapted for receiving audible signals from the second side of the door and converting the audible signals from the second side of the door into electrical signals.

Yet other embodiments could include a mounting module comprising an image sensor adapted for receiving video input signals from a first side of a door and converting the video input signals into output signals; a display module comprising a processing circuit in communication with the image sensor, wherein the processing circuit is adapted for processing the output signals into processed signals, a display in communication with the processing circuit, wherein the display is adapted to be viewable from a second side of the door, and an actuating device in communication with the processing circuit, such that upon activating the actuating device, the processed signals are displayed in the form of an image on the display. Optionally, the mounting module and display module could be packaged as a kit which also comprises a charging module for charging a power source in the display module. In turn, the display module could charge a secondary power source in the mounting module.

Other embodiments could also include methods of identifying visitors positioned at a first side of a door, such embodiments could include: receiving video signals from a first side of a door; displaying the video signals on a display adapted to be viewed from a second side of the door; processing the video signals into process signals, storing the processed signals in a memory device; retrieving the processed video signals from the memory device such that the processed video signals may be displayed on the display as a video image; triggering a triggering mechanism wherein upon the triggering, the video signals are processed into processed signals and the processed signals are stored in a memory device; timing an interval between a first triggering of the triggering mechanism and a second triggering of the triggering mechanism and preventing the storing of the processed signals if the interval is less than a predetermined value; determining the time and date of the triggering of the triggering mechanism and storing the time and date in the memory device, where the triggering is receiving a signal from a motion detecting device, or receiving a signal from a door bell, or receiving a signal from a user interface.

Alternatively, such methods could also include: receiving audible signals from a first side of a door; converting the audible signals into electrical signals; amplifying the electrical signals; and broadcasting the electrical signals through a speaker such that acoustical signals are produced at the second side of a door; storing the electrical signals in a memory device; and retrieving the electrical signals from a memory device such that the electrical signals may be broadcast through the speaker. Such methods could also include sending the processed signals to a network.

What is claimed is:

1. A door viewer, comprising:
an image sensor adapted for receiving video input signals from a first side of a door and converting the video input signals into output signals,
a processing circuit in communication with the image sensor, wherein the processing circuit is adapted for processing the output signals into processed signals,
a memory device in communication with the processing circuit, wherein the memory device is adapted for storing the processed signals
a display in communication with the processing circuit, wherein the display is adapted to be viewable from a second side of the door, and
an actuating device in communication with the processing circuit, such that upon activating the actuating device, the processed signals are displayed in the form of an image on the display,
a triggering mechanism in communication with the processing circuit such that when the triggering mechanism is triggered, the processed signals are stored in the memory device,
a timer circuit in communication with the processing circuit to measure an interval between triggering events, such that storing of the processed signals is prevented if the interval is less than a predetermined value,
a user interface in communication with the image processing circuit, wherein the user interface is adapted to allow the input of user selectable preferences,
an amplifying circuit coupled to the processing circuit,
a first microphone positioned to receive audible signals from the first side of the door, wherein the first microphone is in communication with the amplifying circuit,
a first speaker in communication with the amplifying circuit and positioned on the second side of the door,
a second microphone positioned to receive audible signals from the second side of the door, wherein the second speaker is in communication with the audio processing circuit, and
a second speaker in communication with the amplifying circuit and positioned on the first side of the door.

2. The door viewer of claim 1 wherein the triggering mechanism is selected from the group consisting of: a motion detector, circuitry adapted for determining motion coupled to the processing circuit, a radio receiver, and a user interface.

3. The door viewer of claim 1 further comprising a clock circuit in communication with the image processing circuit to determine the time and date of the triggering of the triggering mechanism.

4. The door viewer of claim 1 further comprising:
a memory device,
an audio processing circuit in communication with the first microphone and the memory device, wherein the audio processing circuit is adapted for processing output signals from the microphone such that the processed signals may be stored in the memory device.

5. The door viewer of claim 1 further comprising a radio transmitter in communication with the processing circuit, wherein the radio transmitter is adapted to transmit the processed signals to a radio receiver which is coupled to a network access point.

6. A door, comprising
a planar main body adapted to be hinged in a door frame,
a digital camera adapted to be coupled to the main body such that the digital camera receives at least one image from a first side of the main body,
a control circuit in electronic communication with the digital camera, wherein the control circuit is adapted for processing signals from the digital camera,
a display in communication with the control circuit,
an enclosure for housing the display and control circuit, the enclosure adapted for coupling to a second side of the door such that the display is viewable from the second side of the main body, and
an actuating device in communication with the control circuit, such that upon activating the actuating device, signals from the digital camera are processed by the processing circuit and displayed on the display.

7. The door of claim 6 further comprising:
a memory device in communication with the control circuit, wherein the memory device is adapted for storing the processed signals.
a triggering mechanism in communication with the control circuit such that when the triggering mechanism is triggered, the processed signals are stored in the memory device.

8. The door of claim 7 wherein the triggering mechanism is selected from the group consisting of: a motion detector, circuitry adapted for determining motion coupled to the processing circuit, a radio receiver adapted to receive signals from a doorbell unit, a radio receiver adapted to receive signals from a motion detection device, and a user interface.

9. A method of identifying a visitor positioned at a first side of a door, the method comprising:
receiving video signals from a device coupled to a first side of a door,
processing the video signals into process signals,
storing the processed signals in a memory device,
retrieving the processed video signals from the memory device such that the processed video signals may be displayed, and
displaying the video signals on a display adapted to be viewed from a second side of the door.

10. The method of claim 9, further comprising triggering a triggering mechanism wherein upon the triggering, the video signals are processed into processed signals and the processed signals are stored in a memory device.

11. The method of claim 10, further comprising timing an interval between a first triggering of the triggering mechanism and a second triggering of the triggering mechanism and preventing the storing of the processed signals if the interval is less than a predetermined value.

12. The method of claim 10, further comprising determining the time and date of the triggering of the triggering mechanism and storing the time and date in the memory device.

13. The method of claim 10, wherein the triggering further comprises receiving a signal from a motion detecting device.

14. The method of claim 10, wherein the triggering further comprises receiving a signal from a door bell.

15. The method of claim 10, wherein the triggering further comprises receiving a signal from a user interface.

16. The method of claim 9 further comprising:
receiving audible signals from a first side of a door,
converting the audible signals into electrical signals,
amplifying the electrical signals, and
broadcasting the electrical signals through a speaker such that acoustical signals are produced at the second side of a door.

17. The method of claim 16 further comprising:
storing the electrical signals in a memory device, and
retrieving the electrical signals from a memory device such that the electrical signals may be broadcast through the speaker.

18. The method of claim 9 further comprising sending the processed signals to a network.
